(19) United States
(12) Patent Application Publication
(10) Pub. No.: US 2015/0258843 A1
(43) Pub. Date: Sep. 17, 2015

(54) RECONFIGURABLE DECORATIVE PLAQUES

(71) Applicant: P. Graham Dunn, Inc., Dalton, OH (US)

(72) Inventor: MARY L. GEISER, North Lawrence, OH (US)

(73) Assignee: P. Graham Dunn, Inc., Dalton, OH (US)

(21) Appl. No.: 14/204,025

(22) Filed: Mar. 11, 2014

(51) Int. Cl. B44C 1/28

(52) U.S. Cl. CPC B44C 1/28

(57) ABSTRACT

Decorative plaques are achieved by various interconnections of independent tiles. The tiles are configured with connector regions uniformly spaced about the peripheries thereof such that they align with the joint regions of other tiles in various end configurations. A friction-fit connector is used to interconnect the tiles at the paired recessed regions. No glue or permanent interconnection media is used, such that the connectors can be removed and the uniformity of the tiles accommodates repositioning and reorientation to achieve a plaque of a new or different configuration, as desired.

### TECHNICAL FIELD

The invention herein resides in the art of decorating accessories of the type that may be placed on a table, hung on a wall, displayed on an easel and the like. Particularly, the invention relates to decorative plaques of the type that may contain photographs, illustrations, motivational or inspirational messages, scripture and the like. Specifically, the invention relates to a decorative plaque assembled from a plurality of interconnected tiles, the tiles and connective devices employed allowing for the configuration of the plaque in any of various geometries, while further accommodating the disassembly and reconfiguration of the plaque in a different geometry.

### BACKGROUND ART

The use of decorative plaques to accessorize a room setting has become commonplace. Such plaques often provide a means for displaying pictures or photographs, decorative illustrations, motivational or inspirational sayings, scriptures, and the like. Presently known plaques are of a fixed configuration and structure. Typically, the plaques are of a unitary and integral one-piece construction, being inflexible as to the specific nature of the display offered by the plaque. Such plaques are not given to accommodating the rearrangement of a room with regard to furniture placement, wall-hanging placement, and the like. Moreover, such plaques, being of a fixed nature, take on a familiar or “old” appearance over time. Additionally, such known plaques are not given to personalization of expression. The purchaser must necessarily find a plaque to his or her liking, or as near thereto as possible, while such do not accommodate the construction of a plaque by the end user in order to satisfy his or her specific needs and desires.

There is a need in the art for decorative plaques that are configurable and reconfigurable by the end user.

### SUMMARY OF THE INVENTION

In light of the foregoing, it is a first aspect of the invention to provide reconfigurable decorative plaques that allow the end user to significantly impact the final appearance of the plaques.

A further aspect of the invention is the provision of reconfigurable decorative plaques that allow the user to change the appearance of the plaques with or without additional purchases.

Still another aspect of the invention is the provision of reconfigurable decorative plaques that allow the interchanging of plaque portions among different plaques.

Yet another aspect of the invention is the provision of reconfigurable decorative plaques that are of structural integrity once assembled, and yet readily disassembled for purposes of reconfiguration.

Still a further aspect of the invention is the provision of reconfigurable decorative plaques that accommodate various geometric configurations of the plaque, such as accommodating horizontal or vertical display with the same constituent elements.

Still another aspect of the invention is the provision of reconfigurable decorative plaques that are easy to use, manipulate, interconnect and change in a cost-effective manner.

The foregoing and other aspects of the invention that will become apparent as the detailed description proceeds are achieved by a decorative plaque, comprising: a plurality of tiles releasably, selectively, and interchangeably interconnectable with each other; and at least one removable and replaceable connector interconnecting adjacent tiles and thereby forming the plaque.

### DESCRIPTION OF DRAWINGS

For a complete understanding of the various objects, techniques and structures of the invention, reference should be made to the following detailed description and accompanying drawings wherein:

FIG. 1 is a front plan view of a decorative plaque made in accordance with the invention in a first arrangement;

FIG. 2 is a back plan view of the decorative plaque of FIG. 1;

FIG. 3 is a front plan view of a decorative plaque using the constituent elements of that of FIG. 1, but in a different arrangement; and

FIG. 4 is a back plan view of the decorative plaque of FIG. 3.

### DETAILED DESCRIPTION OF PREFERRED EMBODIMENTS

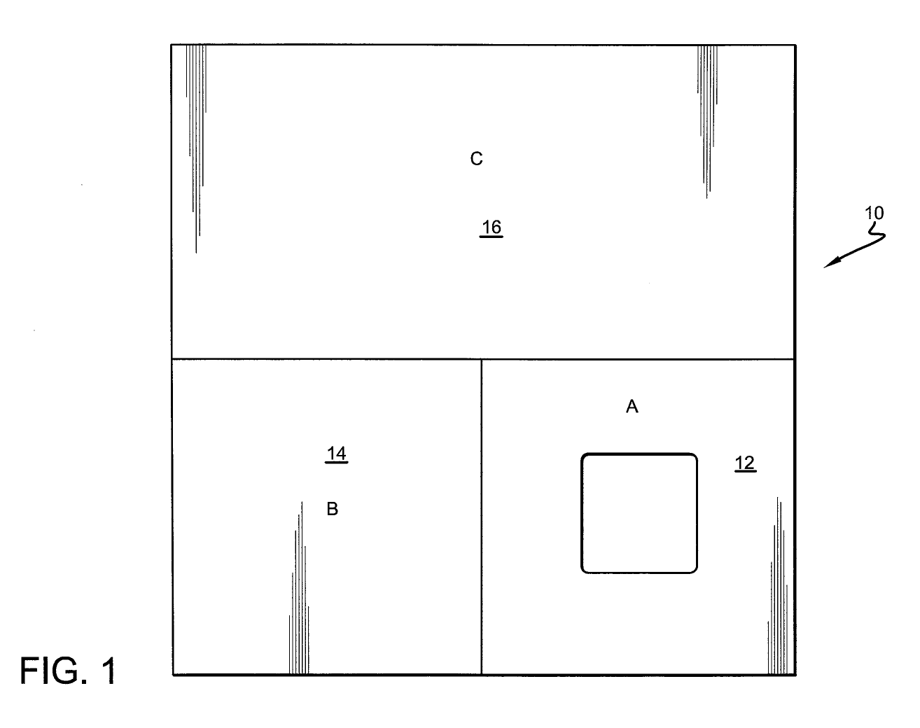

Referring now to the drawings and more particularly FIG. 1, it can be seen that a first embodiment of a plaque made in accordance with the invention is designated generally by the numeral 10. The plaque 10 of this arrangement consists of square tiles 12, 14 interconnected with each other and with a rectangular tile 16. The tiles 12, 14, 16 may be made of any suitable material, such as wood, plastic, fiberboard, mica board, or the like. As shown, the tile 12 has a picture aperture 18 therein, providing a picture frame for receipt of a photograph or the like. The face A of the tile 12 may contain decorative material such as illustrations, sayings, quotations, scriptures, and the like. Similar decorative-type materials can appear on the face B of the tile 14 and the face C of the tile 16.

It will be appreciated that the plaque 10 may be of any of various geometric configurations as can the individual tiles 12, 14, 16. In the embodiment of FIG. 1, the tiles 12, 14 are square, having a side dimension that is one-half the length of the rectangular tile 16, and with the width of the tile 16 being the same dimension as a side of the square tiles 12, 14. The resultant assembly of the plaque 10 is that of a square plaque having four times the area and double the perimeter of one of the tiles 12, 14.

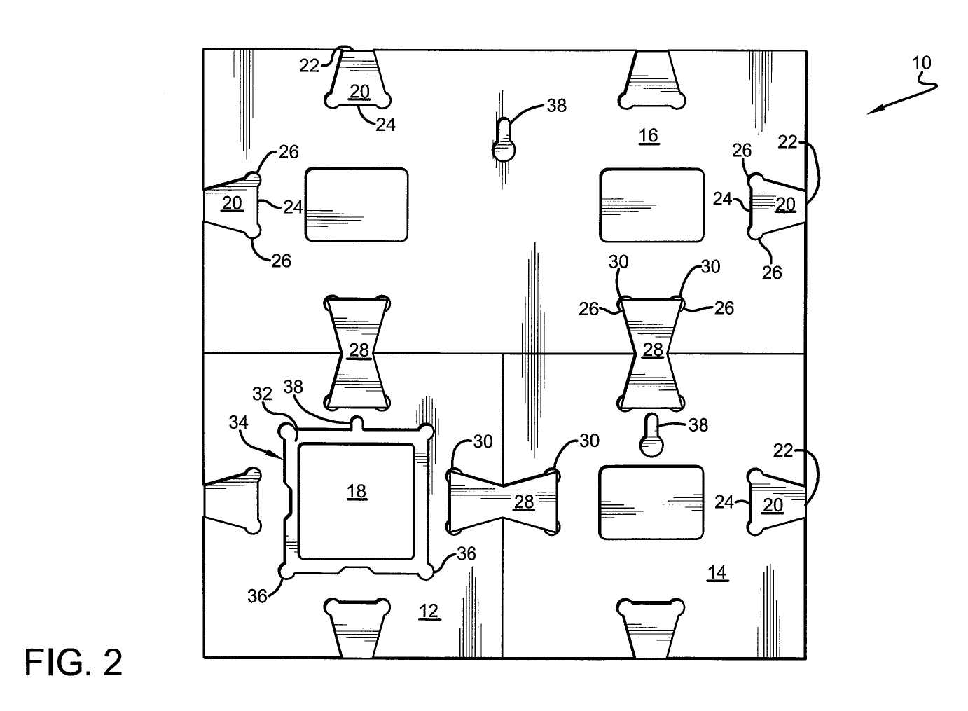

With reference now to FIG. 2, an appreciation can be obtained of the structure and methodology employed for interconnecting the tiles 12, 14, 16. As shown, the backs of the tiles contain recessed regions 20 uniformly spaced about the peripheries of the tiles 12, 14, 16. These recessed regions are, in a preferred embodiment, of a truncated triangular shape, as shown. The narrow portions 22 of the recessed regions 20 are positioned at the edges of the associated tiles. The larger portion 24 of the recessed regions 20 is distal from the edge toward the interior of the tile, as shown. It will be appreciated that the recessed regions 20 are characterized by rounded corners 26 to accommodate the removal of connectors 28 received in paired recessed regions 20. As shown, the connectors 28 are configured as the aligned recessed regions 20 in abutting tiles 10, 12, 14. The connectors extend from a center necked-down region to expanded ends corresponding to the cavity defined by paired and opposed recessed regions 20. The connectors 28 are generally of a “butterfly” configuration.

The connectors 28 have sharp corners 30, leaving space in the recessed rounded corners 26 of the recessed regions 20. In FIG. 2, the connectors 28 are shown as received within the cavities defined by the paired and opposed recessed regions 20. The connectors 28 have a thickness that corresponds to the depth of the receiving cavity, and the perimeter of the connector 28 is slightly larger than the perimeter of the cavity defined by mating recesses 20, such that the connectors 28 are received therein by a press, interference, or friction fit. To accommodate the insertion of the connectors 28, the bottom peripheral edges (not shown) of the connectors 28 may have a slight bevel to facilitate placement. It will be appreciated that the connectors 28 may have a perimeter that is slightly greater than that of the recess 20 about the entirety thereof, or just at selected areas to accommodate the friction fit.

No glue or adhesive is used between the connector 28 and its receiving cavity. Accordingly, the connector 28 may be removed for purposes of reconfiguration of the resultant plaque. Once reconfigured, the connectors 28 may be placed in the corresponding aligned recessed regions 20, forming appropriate cavities. The area between the sharp corners 30 of the connectors 28 and the rounded corners 26 thereof, allows for the insertion of a tool, such as a small screwdriver blade, knifepoint, or the like to pry or otherwise urge the connector 28 from the cavity of the recesses 20.

With continued reference to FIG. 2, it can be seen that a clamp 32 is provided to be received by peripheral recess 34 defined about the picture aperture 18. Again, the clamp 32 is received in the peripheral recess by an appropriate press, interference, or friction fit, and rounded corners 36 are again provided to accommodate access to the corners of the clamp 32 for removal thereof. The clamp 32 provides a means for holding a picture, illustration, or the like in the aperture 18.

As further shown in FIG. 2, hanger slots 38 are centrally positioned toward an edge of the associated tiles to accommodate hanging on a nail, screw head, or the like. In that regard, hanger slots 38 are preferably of a key slot configuration and are undercut for the purpose of receiving the hanger head.

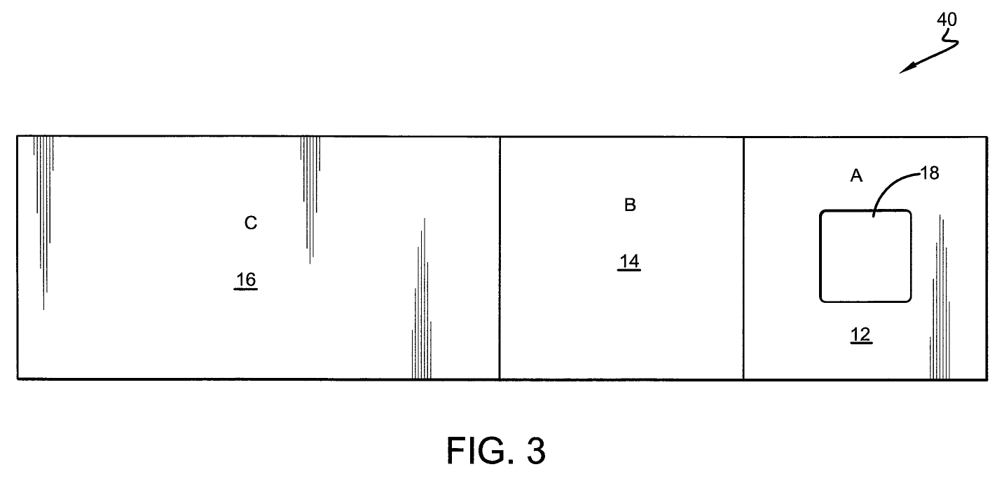

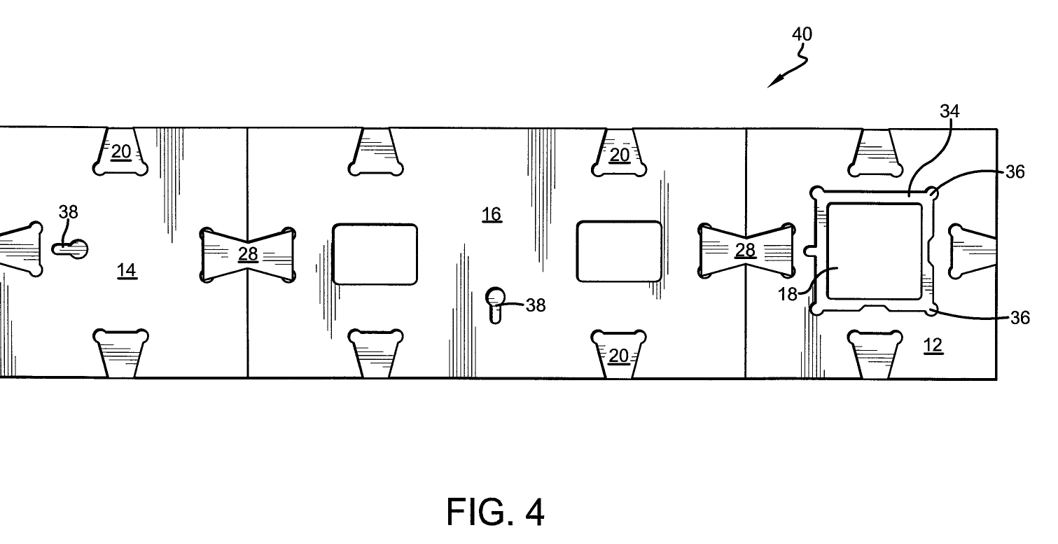

With reference now to FIG. 3, it can be seen that a plaque 40 of alternate configuration from the plaque 10 may be made using the same tiles 12, 14, 16 as were used for forming the plaque 10. The back of the plaque 10 is shown in FIG. 4, where it can be appreciated that the connectors 28 are now used to interconnect the various tiles in an aligned rectangular configuration with the hanger slot 38 of the tile 14 providing for vertical hanging. In this arrangement, the plaque 40 again has 4 times the area of a single square tile 12, 14, and a perimeter 2.5 times thereof.

By uniformly positioning the recessed regions 20 about the perimeters of the various tiles and the positioning of appropriate hanger slots 38 centrally of intended “top” edges of the tiles, and by employing a press fit rather than a glued or permanent joint, the reconfiguration demonstrated above can be achieved. Not only can the same tiles be used, but other tiles can be interjected in various combinations and permutations in order to achieve any of numerous geometric configurations for the resulting plaque.

Thus, it can be seen that the various aspects of the invention have been achieved by the structures and techniques presented above. While in accordance with the patent statutes, only the best mode and preferred embodiments of the invention have been presented and described in detail, the invention is not limited thereto or thereby. Accordingly, for an appreciation of the true scope and breadth of the invention, reference should be made to the following claims.

What is claimed is:

1. A decorative plaque, comprising:
a plurality of tiles releasably, selectively and interchangeably interconnectable with each other; and
at least one removable and replaceable connector interconnecting adjacent tiles and thereby forming the plaque.

2. The decorative plaque according to claim 1, wherein said tiles have recessed regions along edges thereof for selectively receiving said connector.

3. The decorative plaque according to claim 2, wherein said connector is matingly received in opposed recessed regions of immediately adjacent tiles.

4. The decorative plaque according to claim 3, wherein said recessed regions of immediately adjacent tile edges establish a continuous cavity receiving said connector.

5. The decorative plaque according to claim 4, wherein said connector mates with edges of said cavity with a friction fit.

6. The decorative plaque according to claim 5, wherein said cavity has a width interior of an associated tile edge that is greater than a width of said cavity at said tile edge.

7. The decorative plaque according to claim 6, wherein said cavity is of a truncated triangular configuration extending inwardly from said tile edge.

8. The decorative plaque according to claim 5, wherein each said tile of the plaque has edge lengths that are an integral multiple edge length of all other tiles in the plaque.

9. The decorative plaque according to claim 8, wherein a face of said tiles contains a motivational presentation.

10. The decorative plaque according to claim 9, wherein one of said tiles comprises a picture frame.

11. The decorative plaque according to claim 10, wherein one of said tiles has a hanger slot cut into a back of one of said tiles.
